(19) United States
(12) Patent Application Publication
(10) Pub. No.: US 2018/0136814 A1
(43) Pub. Date: May 17, 2018

(54) SYSTEMS AND METHODS FOR MULTI-DIMENSIONAL AUGMENTED AND VIRTUAL REALITY DIGITAL MEDIA INTEGRATION

(71) Applicant: Zyndo, LLC, Manalapan, NJ (US)

(72) Inventors: Biju Parekkadan, Cambridge, MA (US); Zachary D. Lieberman, New York, NY (US); Jason R. Webb, West Long Branch, NJ (US)

(21) Appl. No.: 15/656,594

(22) Filed: Jul. 21, 2017

Related U.S. Application Data
(60) Provisional application No. 62/365,722, filed on Jul. 22, 2016.

(51) Int. Cl. G06F 3/0481; G06T 19/00; G06F 3/0482

(52) U.S. Cl. CPC G06F 3/04815; G06T 19/003; G06T 11/60; G06F 3/0482; G06T 2200/24; G06T 19/006

(57) ABSTRACT

A system and accompanying methods provide for the creation and navigation of interactive, three-dimensional media presentations. A three-dimensional presentation is received, and includes a three-dimensional canvas having integrated therein a plurality of two-dimensional content elements from a first content source and a plurality of three-dimensional content elements from a second content source. The two-dimensional content elements and the three-dimensional content elements relate to a common topic. The three-dimensional presentation is displayed to a user on a user device by moving a virtual camera about the three-dimensional canvas over a plurality of defined motion paths. While displaying the three-dimensional presentation to the user, user navigation instructions with respect to a first one of the integrated content elements are received. In response thereto, the three-dimensional canvas and/or the virtual camera within the three-dimensional canvas are spatially manipulated to cause a second one of the integrated content elements to provide context relating to the first integrated content element.

### CROSS-REFERENCE TO RELATED APPLICATION

This application claims priority to and the benefit of U.S. Provisional Patent Application No. 62/365,722, filed on Jul. 22, 2016, the entirety of which is incorporated by reference.

### TECHNICAL FIELD

This description relates generally to digital media manipulation and presentation in augmented and virtual reality space and, more particularly, to combining two-dimensional, three-dimensional, and audio content to form a multi-dimensional, multimedia presentation, thereby enriching and contextualizing subject matter for the purpose of maximizing attention span, incentives, and enjoyment of the presentation viewer.

### BACKGROUND INFORMATION

Digital media has become a powerful forum in which to communicate. As electronic devices such as computers, phones, tablets, and virtual reality instruments have become increasingly pervasive in our society, many people have access points to acquire digital media. In an ideal interaction between a digital media content creator and user, the presentation of the media would be flawless such that the information content would be experienced by the user as it was envisioned by the content creator. There continues to be a major gap in media creation systems that limits this ideal interaction from being reached, causing a loss of information transfer from creator to user.

The information content presented by digital formats has already been shown to enhance education and retention time compared to non-digital methods. Yet, content learning and retention is a multi-factorial problem that is not being isolated and addressed individually by current media creation systems. For example, current media creation systems are limited to delivering content in a single stream of dimensionality (two-dimension (2D), three-dimension (3D), or potentially four-dimension (4D) in the case of timecode-based video). There exist opportunities to integrate 2D, 3D, and 4D content simultaneously in order to improve the perceived user experience, including in applications of content learning and entertainment. Users also absorb content at different rates. In the case of 4D, a continuous stream of content is presented to the user, though is not controlled by the user on a frame-to-frame basis. Users who digest and retain content better in discrete blocks may not be served by conventional video presentation techniques.

Moreover, visual interactive experiences are also reinforced by other sensory input in synergistic ways. Engaging the touch, hearing, and visual senses can non-linearly increase enjoyment, memory, and recall abilities. To date, no single system has been identified that can trigger the same level of sensory input with output functionality that has utility in the entertainment, publishing, and presentation markets as a specific application of use. Finally, users have different motivations and incentives to entertain and educate themselves that are left at their own discretion. There exists an opportunity to provide incentives to experience content during the use of digital media using non-profit and for-profit methods.

### SUMMARY

A system and accompanying methods provide for the creation and navigation of interactive, three-dimensional media presentations. In one aspect, a three-dimensional presentation is received, and includes a three-dimensional canvas having integrated therein a plurality of two-dimensional content elements from a first content source and a plurality of three-dimensional content elements from a second content source. The two-dimensional content elements and the three-dimensional content elements relate to a common topic. The three-dimensional presentation is displayed to a user on a user device by moving a virtual camera about the three-dimensional canvas over a plurality of defined motion paths. While displaying the three-dimensional presentation to the user, user navigation instructions with respect to a first one of the integrated content elements are received. In response thereto, the three-dimensional canvas and/or the virtual camera within the three-dimensional canvas are spatially manipulated to cause a second one of the integrated content elements to provide context relating to the first integrated content element. Other aspects of the foregoing method include corresponding systems and computer-readable media.

Various implementations of these aspects can include one or more of the following features. The first integrated content element can include a two-dimensional content element and the second integrated content element can include a three-dimensional content element. The first integrated content element can include a three-dimensional content element and the second integrated content element can include a two-dimensional content element. The three-dimensional presentation further can include an auditory component from a third content source presented in synchronization with navigation of the three-dimensional canvas. The first content source and the second content source can include data and metadata that specify at least one of a common topic and a navigation path for generating informational content for a given field of application. The two-dimensional content elements can include images, animations, videos, and/or text. The three-dimensional content elements can include three-dimensional object models, three-dimensional video, and/or three-dimensional objects created from layered two-dimensional content elements. Content elements from the first content source and the second content source can be transformed into a common type for manipulation on the three-dimensional canvas. The three-dimensional canvas can be displayed in an augmented reality or virtual reality environment using an augmented reality or virtual reality user device.

In another implementation, a plurality of panels are displayed in the three-dimensional canvas, with each panel corresponding to an area of the three-dimensional canvas that includes one or more of the integrated content elements. Two or more of the panels can be displayed in different dimensional layers in the three-dimensional canvas to create a quasi-three-dimensional parallax effect. Two or more of the panels can also be displayed in different dimensional layers that change based on an orientation of the user device.

In a further implementation, an interface within the three-dimensional canvas that includes visual representations of the plurality of panels is provided. User input is received that indicates a selection of one of the visual representations of the panels, and, in response to the input, the user is navigated to an area of the three-dimensional canvas corresponding to the panel represented by the selected visual representation.

Other aspects and advantages of the invention will become apparent from the following drawings, detailed description, and claims, all of which illustrate the principles of the invention by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, emphasis instead generally being placed upon illustrating the principles of the invention.

FIG. 1 depicts an example high-level architecture of a system for providing three-dimensional, interactive media presentations.

FIG. 2 depicts an example use diagram for receiving, opening, and interacting with an application configured to present three-dimensional, interactive media presentations.

FIG. 3 depicts an example use diagram for a production system configured to create three-dimensional, interactive media presentations.

FIGS. 4A-4C depict an example transformation of a two-dimensional layered image asset into a three-dimensional asset.

FIGS. 5A and 5B depict example transformations of two-dimensional page layouts into three dimensions.

FIGS. 6A and 6B depict examples of user-based transition events in a three-dimensional environment.

FIG. 7 depicts an example menu system infrastructure independent of viewing a three-dimensional presentation.

FIG. 8 depicts an example of multi-dimensional movement within a three-dimensional environment.

FIG. 9 depicts an example of different movements in panel transitions within a three-dimensional environment.

FIGS. 10A-10D depict an example use case for a three-dimensional, interactive presentation.

### DETAILED DESCRIPTION

Described herein are systems and accompanying methods for receiving input media data from different content sources and transforming the data into a common content type in order to select and integrate data for customized three-dimensional media presentations. Content sources can take various forms, including content received over a network from a data source (e.g., a media content server) in real-time as needed or stored for later use, media content received by reading or extracting content from a data file or application stored on a computer-readable medium, or other forms from which electronic media data can be received or retrieved. Content sources can include content elements, which can include, for example, media items such as video, images, audio, text, animations, three-dimensional models, and so on. As further described below, such content can be integrated into a three-dimensional environment by transforming the content into a common format or data type recognizable by a computer application that generates the environment with populated content. The media presentations described herein can be provided to a user for viewing on various user devices, for example, mobile devices (smartphones, tablets, laptops), desktop computers, gaming systems, televisions, augmented reality/virtual reality (AR/VR) devices, smart glasses, and so on. When using an AR/VR device, the user may experience the presentation as if he is within it or surrounded by it.

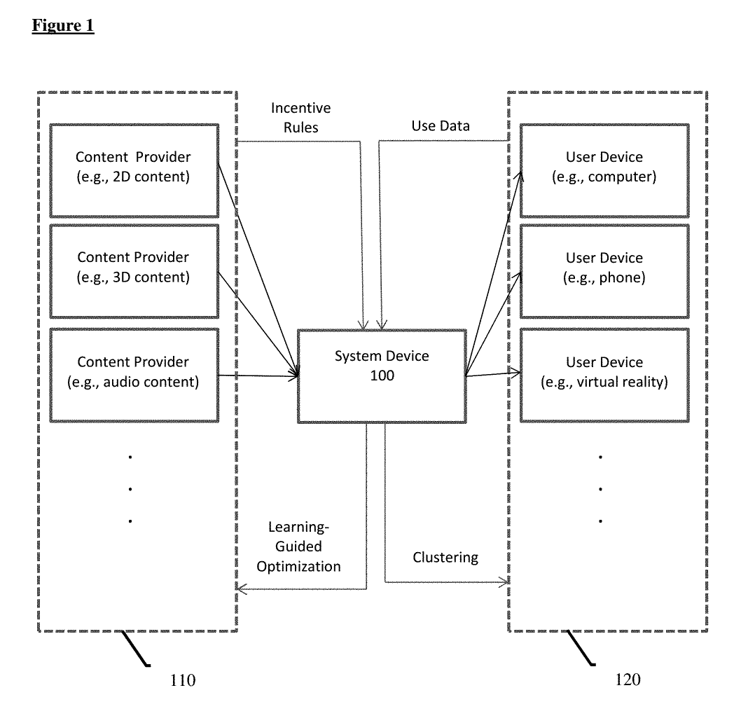

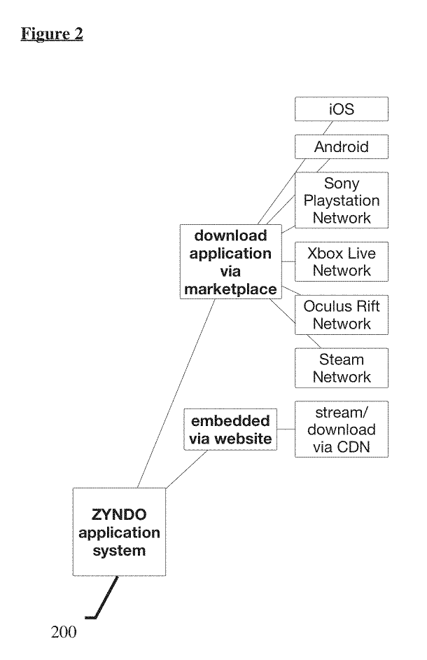

FIG. 1 depicts one implementation of a system for integrating different forms of media content into a navigable three-dimensional presentation, and providing the presentation to a device user. The system includes a system device 100 that can receive various forms of 2D, 3D, audio, and other media content from content providers 110, such as content creators and media servers. A presentation creator can use system device 100 and content received from content providers 110 to develop and export a three-dimensional presentation for users to experience on various user devices 120. Presentations can simultaneously include, for example, two-dimensional content pages which contain content elements (e.g., images, text, video, etc.), three-dimensional content (e.g., 3D models, virtual reality or augmented reality environments, etc.), structured content types (e.g., html, xml, etc.), audio content, and the like.

In one implementation, the system includes production software, which can execute on the system device 100, in the form of a standalone application, plugin, module, or other program used to create and edit the three-dimensional presentations described herein. The production software can include functionality to export the created presentation into presentation software that can be natively executed on the different user devices 120 or that can be executed using specialized video player software, browser plugins, etc. Notably, the production software can transform layered 2D graphic content (e.g., from editing software like Adobe Photoshop) into a 3D object by isolating individual layers of the 2D content and defining the layers in separate three-dimensional spaces. The presentation software can then apply a rendering of the layers of the transformed three-dimensional content that varies based on the physical orientation of the device being used or of the user. For example, as a user tilts his smartphone or moves his head in VR goggles, the separate three-dimensional layers can move with respect to each other in a quasi-parallax manner. The various content elements in the presentation can be laid out in an infinite reality-based or virtual-reality-based three-dimensional canvas, and can include an infinite 3D background which can provide context and an immersive quality to the presentation, or may anchor its various content within real-world and real-time 3D environments (as in augmented reality applications).

The presentation can be navigated by user interaction (e.g., touch, gaze, voice, controller, Global Positioning System (GPS)/geo-location) in discrete times, and this navigation can transition from one frame/page/panel to the next in an infinite 3D canvas format. The presentation can be localized into any language for different users. The presentation can also store user interactions with the presentation, such that these measurable factors can be associated with use, learning, enjoyment, and comprehension to optimize the presentation for different users. A user can switch the presentation between multiple layouts of the same content within the same application (e.g., portrait, landscape, virtual reality, augmented reality) and with different camera flight/transition styles (linear 2D movement, 3D movement, etc.). Layouts can be created automatically by the system or created or customized by a presentation producer. The final presentation can be published across multiple digital media devices (e.g., desktop or personal computer, tablet, cell phone, e-reading device, television, video gaming console, virtual reality device, augmented reality device) or on the world-wide-web for downloading as a native application or local execution within a browser.

In some implementations, the media presentation is used to distribute publishing content in the form of a magazine, journal, or book content. The presentation can also be used to distribute instructional content for the use of consumer goods and services, or marketing/sales content for the creation of a virtual sales force for goods and services. The media presentation can also serve as an entertainment experience, as a virtual world, or a game. The presentation can be directed to a common topic or theme, which can include multiple sub-topics/sub-themes. Various content elements in the presentation can be related to the common topic; for example, a presentation guiding a user through a virtual representation of an ancient city can include three-dimension models of buildings as well as historical event explanatory text that appears when the user interacts with particular buildings.

In some implementations, the system provides for user interaction design goals to be a feedback cycle between content sources 110 and users experiencing the presentation through user devices 120. The system device 100 receives incentive rules and content from content sources 110 and, based thereon, creates, compiles, licenses and distributes a new media package (e.g., a media presentation) to users that acquire the new package via electronic user devices 120 (e.g., computer, phone, video gaming console, virtual reality device, augmented reality device). The system device 100 also receives information relating to user demographics and usage data that is measured from the user devices 120 and analyzes content interaction, amongst other measurable events of the content. This received information can be fed back into an analytics database that associates use with learning metrics to optimize the content for clusters of users.

In some implementations, the system includes a database or content server for storing media content, templates, and/or media presentations. Media presentations can be presented to the user, stored on a content server for subsequent retrieval, and/or transmitted to a user device 120. In some implementations, a content identifier is provided to the user that facilitates the identification and retrieval of media presentations from the content server. In such cases, the media presentation can be retrieved from the content server and provided to the user device 120 in response to receiving the content identifier. In one implementation, the content identifier is received from a requestor other than the user, thereby allowing users to view and/or download presentations created by others. The system can also enable the networking of multiple users to share the media content amongst each other (peer-to-peer). The database or content server can also be used in a marketplace environment where content, templates, and/or presentations can be obtained by users for free or for a cost. In one example, the marketplace includes various templates for presentation layouts, styles, effects, camera movements, graphical user interface widgets (e.g., an interactive Gantt chart), and the like, that can be used when creating a presentation.

In some implementations, he system includes a licensing server to determine whether requests to receive content and/or presentations comply with one or more distribution restriction policies and/or content restriction policies. Users can provide monetary value for the presentation and interact with the system to provide payment information and, in return, receive a legally-licensed copy of the presentation. In some instances, a content provider can make a trade or donation on behalf of the user for acquisition and/or use of the presentation, at which point the user can also receive a legal copy of the presentation. In such instances, the user can select from a library of sponsored content (e.g., advertisements or other typical content provided by a sponsor whether for-profit or non-profit). The sponsor can then compensate the licensor for the opportunity to have their sponsored content paired and possibly distributed with the licensed content. As a result, the user receives the desired licensed content for free, the sponsor increases the audience for its advertising message, and the licensor receives licensing fees for the downloaded content. In other words, the system can serve as a for-profit or non-profit marketplace. In one implementation, licensed media content attributed to a content licensor (such as audio and/or video files) and sponsored media content attributed to a sponsor (such as audio and/or video advertisements) can be presented to a user, and, at the user's request, can be combined to create a user-specified media presentation.

A content licensor can be an individual, company, artist, or a media company that owns or has legal authority to license media content. In some implementations, the media content (and in some cases the sponsored content instead of or in addition to the licensed content) are modified (e.g., edited, cut, shortened, lengthened, repeated, etc.) based on attributes of the licensed content and/or attributes of the sponsored content. The combination of the requested licensed content and the sponsored content can, in some instances, be checked against content restriction policies. The content restriction policies can be supplied by the content licensor, the sponsor, or in some cases, both.

In certain implementations, payment of license fees can be made from the sponsor to the content licensor. The receipt of requests for the user-specified media presentation and/or the provision of the user-specified media presentation to users can be tracked to determine, for example, the number of requests received, the number of requests fulfilled, the users that submitted such requests and/or whether the requests and responses thereto comply with distribution restriction policies. The payment of licensing fees can, in some cases, be based on the tracking results.

In another implementation, free, advertising-sponsored downloads can be provided to users as follows. A request is received, e.g., from a user of the system, to combine user-selected licensed content (e.g., an MP3 file) supplied by a first entity with user-selected sponsored video (e.g., a video commercial) attributed to a second entity. The licensed content and/or the sponsored video content are modified based on attributes of either or both, and are combined, thus creating a user-specified media presentation. Licensing fees can then be transferred from the second entity to the first entity. In some instances, the attributes of the files are provided with the files by the licensor, sponsor, and/or users, or are automatically determined.

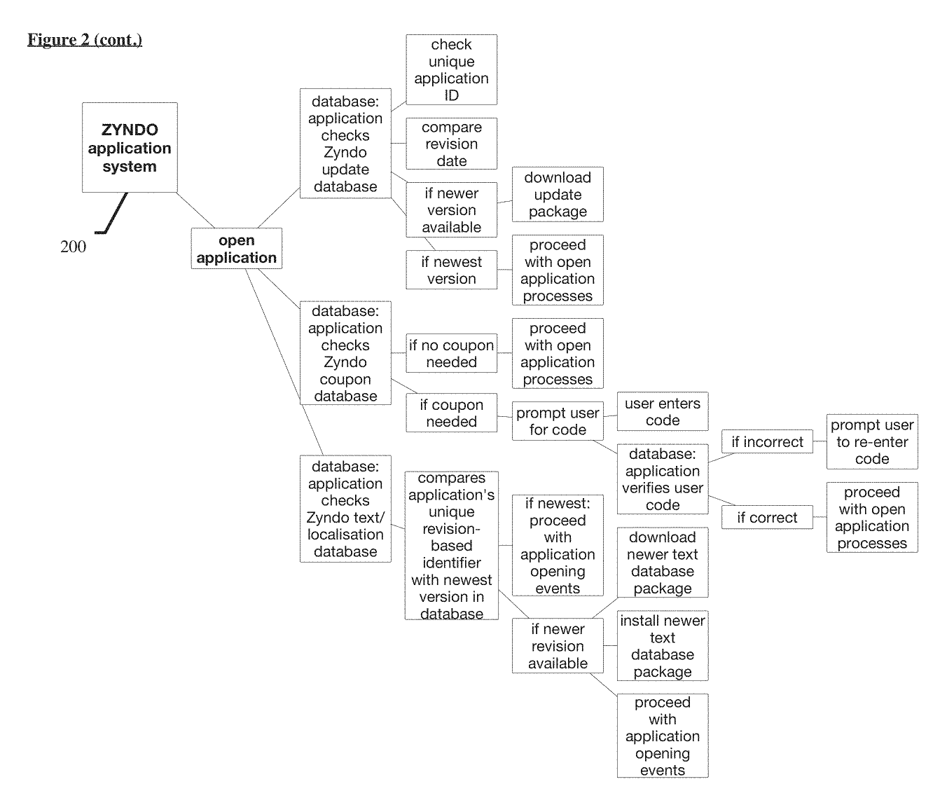

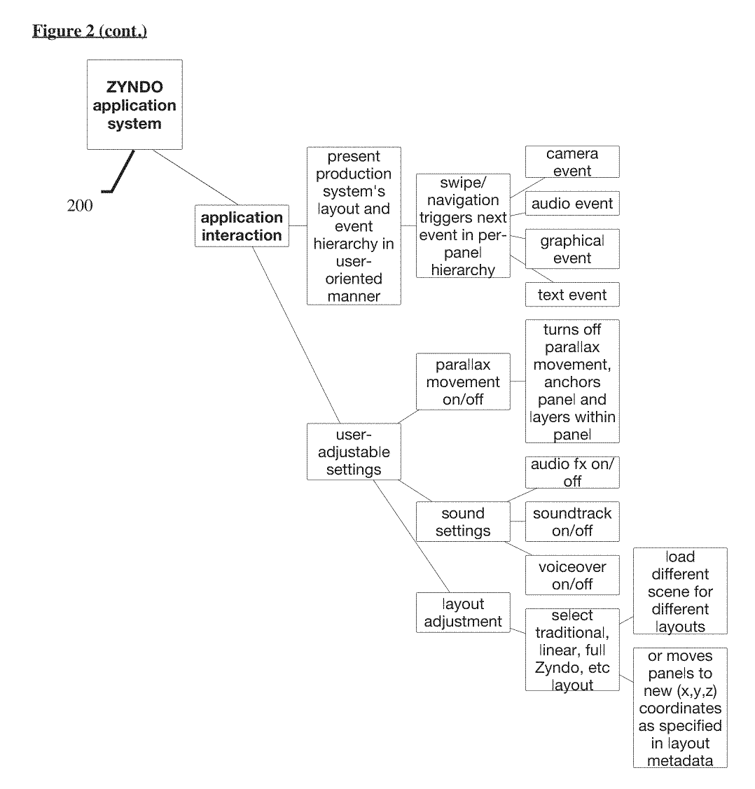

FIG. 2 depicts an example use diagram for receiving, opening, and interacting with an application 200 configured to present media presentations as described herein to a user. The application 200 can be obtained in various manners, such as downloading it from an online marketplace (e.g., iOS Apple Store, Android Google Play Store, Sony PlayStation network, Xbox Live network, Oculus Right network, Steam network, etc.), or accessing an embedded version of the application 200 via a website (this form of application can be, e.g., streamed or downloaded using a content delivery network).

Upon opening the application 200, a check can be made to an application provider database to determine if an update to the application 200 is necessary. If so, an update package can be downloaded and applied. In some implementations, a coupon database can also be queried to determine if a coupon is needed to use the application 200 or obtain a media presentation. If a coupon is needed, the application 200 can prompt the user for a code, which can be verified by the application provider database. The database can also be queried to determine if any information is needed to localize the application 200. For example, a text database or updates thereto can be downloaded and applied to the application 200 to ensure that the application 200 displays the user's selected language.

Various interactions with the application 200 can be performed when opening and experiencing a three-dimensional presentation through the application 200. In one implementation, the presentation layout and event hierarchy are displayed in a user-oriented interface. The user can navigate through the presentation using the interface. Navigation can be accomplished using physical controls on a user device (e.g., touchpad swipes and taps, mouse movement, keyboard presses, controller button presses, etc.), gestures (e.g., head movements, body movements, hand movements, eye movements, etc.), or other manners of expressing navigational intent. As one example, a smartphone user can swipe to navigate from one interface panel to another, and then tap on the panel associate with the portion of the presentation to which he wants to navigate in 3D space.

Navigation of the 3D canvas in the presentation can also trigger various events, including camera movement, audio, graphical changes, text manipulation, and so on. In some implementations, content elements integrated into the 3D canvas are contextually related. While displaying the three-dimensional presentation on a user device, a user can take a navigation action (e.g., movement, manipulation, selection, etc.) with respect to one content element and, in response, another content element can provide visual context relating to the first content element. This context can be provided by manipulating (spatially, temporally, graphically, or otherwise) the three-dimensional canvas, the camera, and/or the content elements. As one example, a user navigates through a three-dimensional rendering of a museum filled with three-dimensional models of artifacts. As the user approaches an artifact, he is able to interact with the artifact by selecting it. This causes the user to be moved within the artifact in the 3D environment (e.g., moving the user's point-of-view camera through the canvas, or moving the canvas as the camera remains stationary), where panels are present that have two dimensional text and graphical elements providing information about the artifact and its place in the presentation.

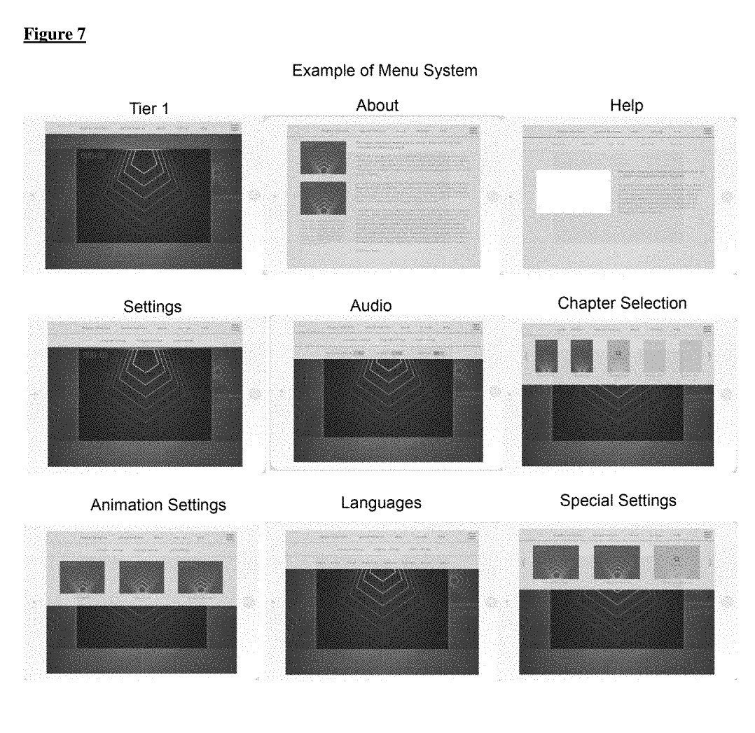

Still referring to FIG. 2, the application 200 can include various user-adjustable settings, which can be made accessible to the user through an interface like that shown in FIG. 7. Such settings include toggling parallax movement (e.g., allowing panels to move with respect to each other in a parallax manner vs. anchoring panels and layers within a panel); toggling and adjusting the volume of audio, soundtracks, voiceovers, sound effects, etc.; and adjusting the presentation layout.

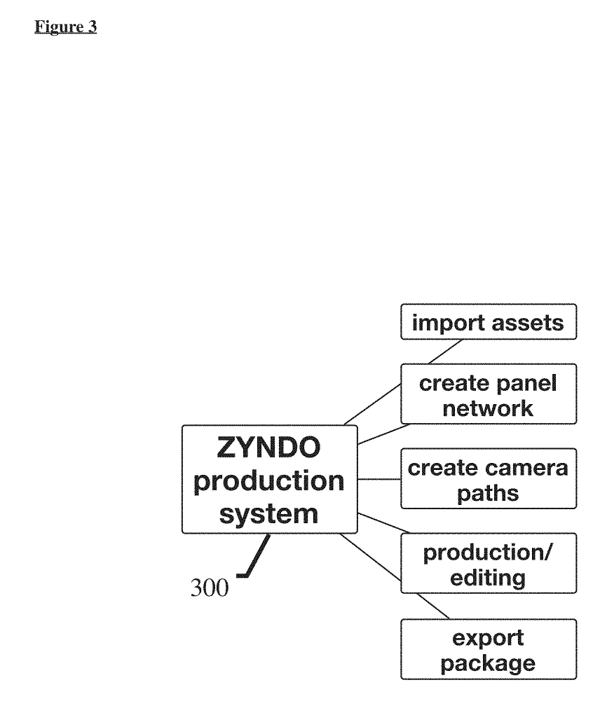

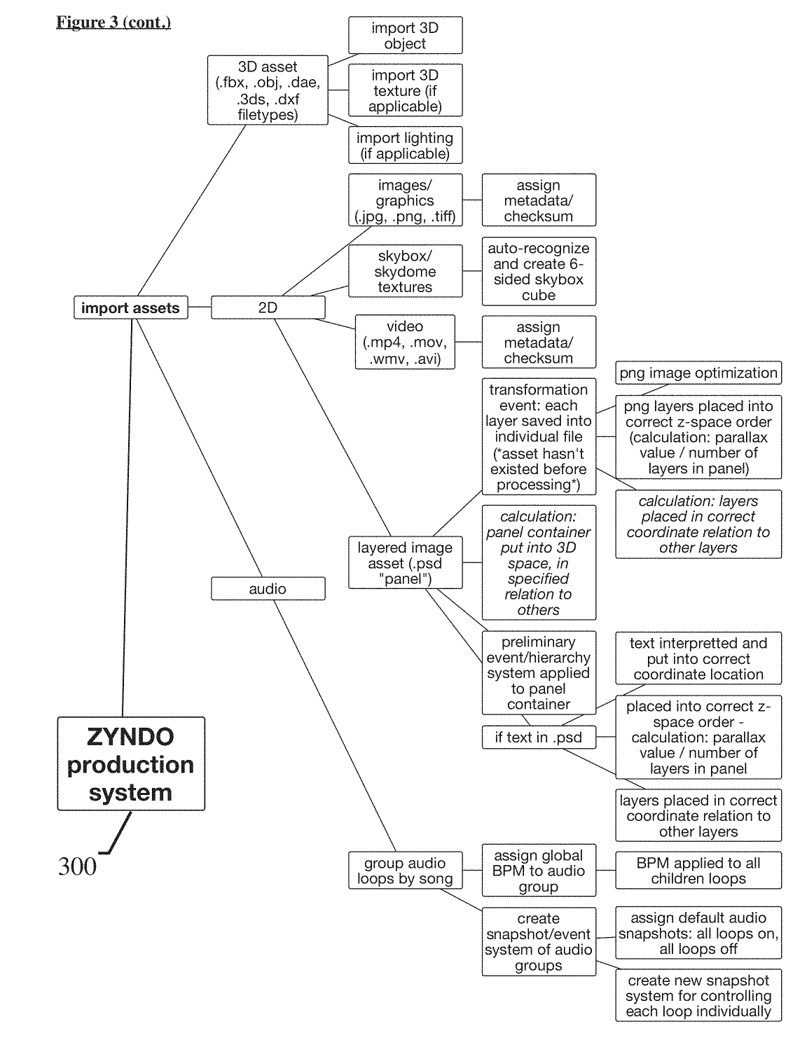

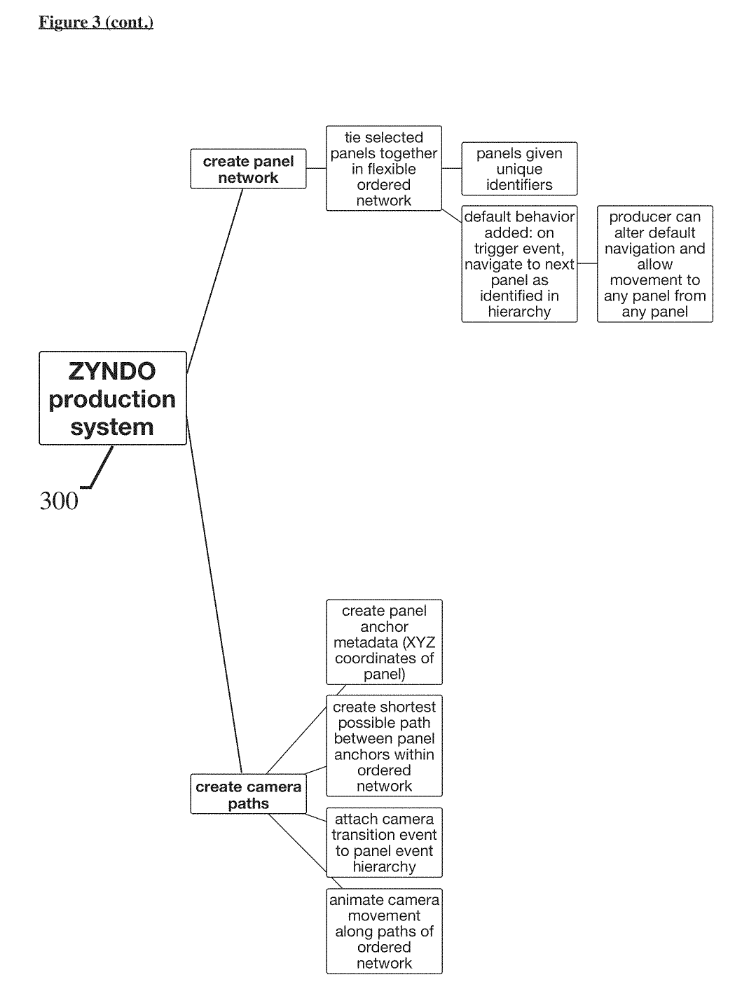

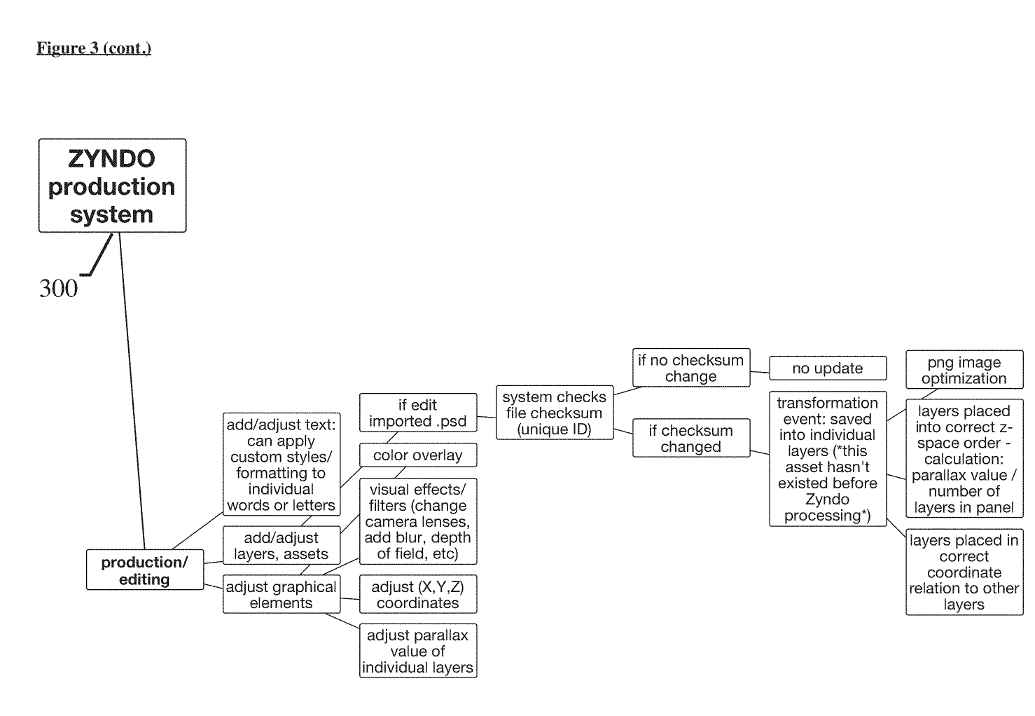

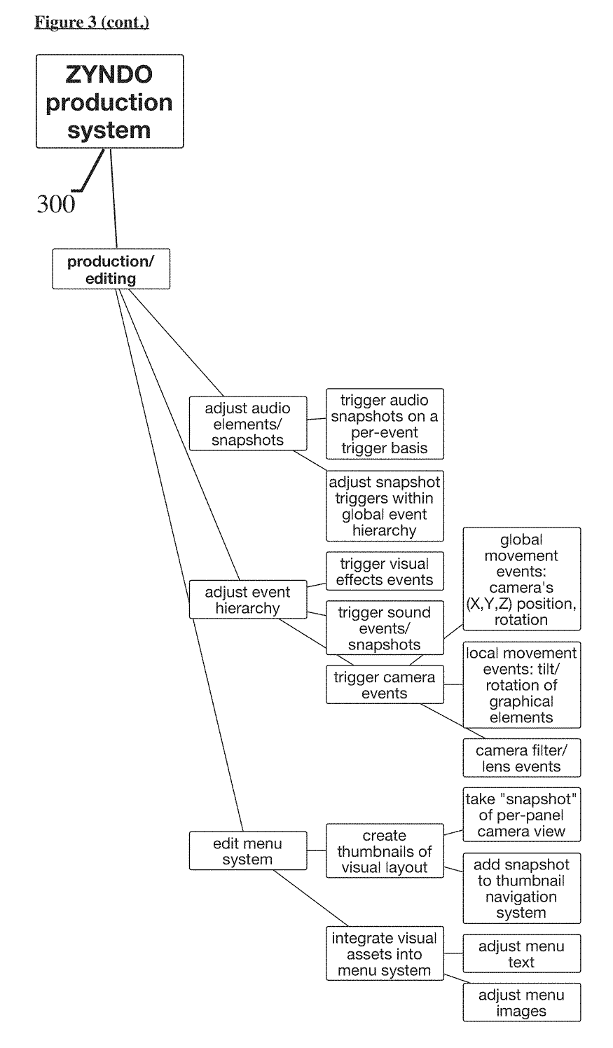

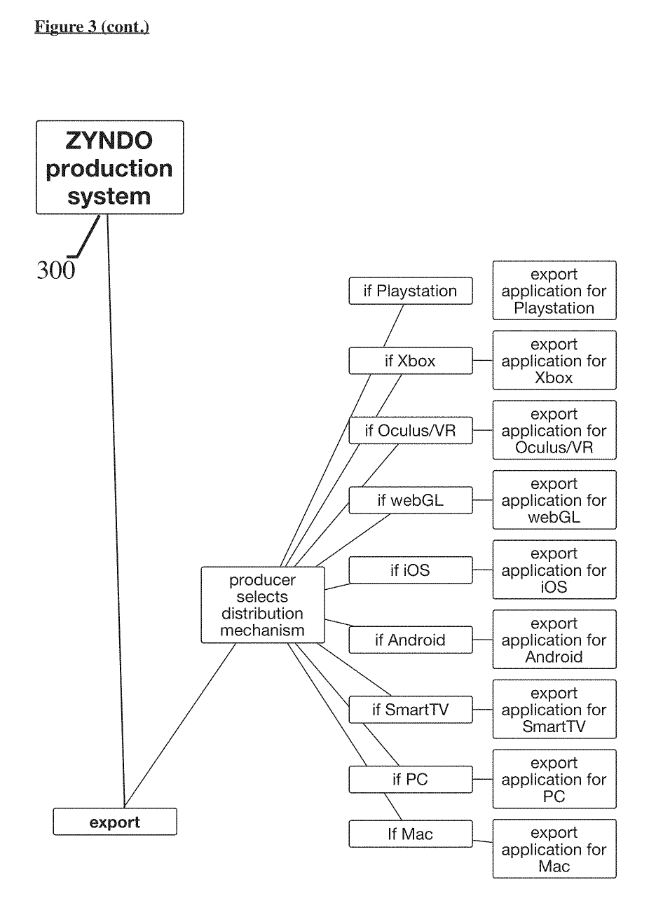

FIG. 3 depicts an example use diagram for a production system 300 configured to create the three-dimensional media presentations described herein, including functionality such as importing media assets, defining of initial camera paths to move among visual representations of the assets (e.g., in a virtual reality environment), editing the media presentation, and exporting the presentation to a file.

The production system 300 can import assets from sources of content to be used in creating a 3D presentation. Such assets can include, for example; 3D assets that can have defined models, textures, and lighting (e.g., file types .fbx, .obj, .dae, .3ds, .dxf); 2D objects, including images/graphics (e.g., file types .jpg, .png, .gif, .tiff), skybox/skydome textures (which can be auto-recognized and used in creating a skybox cube), and layered image assets (the processing of which is described in further detail below); and audio. The assets can be transformed into or associated with pre-assigned values that are of a common informational type for the purpose of manipulating the content in 2D and 3D space. This step enables the integration of content formats of different dimensionality and type (e.g., 2D, 3D, audio content streams) into elements of a common form. Such form can be, for example, a common data format that defines a set of properties for each object (e.g., object type, spatial location in the 3D environment, orientation, temporal location in the timeline of the presentation, whether the object can be manipulated or selected, dimensions, texture, associated URL, and any other property that would be useful to associate with a content element in the three-dimensional presentations described herein). The importing and processing of audio content can include grouping audio loops by song, category, or other identifier, normalizing audio to a particular beat-per-minute (BPM) value, and providing the ability for a presentation creator to control sound loops individually and associate them with events, triggers, and/or locations in the 3D environment.

Once imported assets (content elements) have been transformed and normalized, they can be organized into a cohesive network where the elements can be clustered per user-specified groups and fields of view. The production system 300 can be used to define and create this network, which can include nodes or panels defining a 3D presentation. The nodes/panels can each have an associated unique identifier assigned by the production system 300. A node or panel can be, for example, a spatial and/or temporal location in the presentation that has associated content elements existing in the 3D environment of the presentation, as well as events that can be triggered upon a user navigating to the node, associated audio, and other associated properties. A node or panel can also represent, for example, anchored three-dimensional pages or virtual wall space on a three-dimensional canvas on which content elements can appear, and which can also be extrapolate into corresponding coordinates for representation in augmented reality space. Nodes and panels can be individually placed and/or formed into groups, and can be interconnected by paths that define how a user can navigate among them. The paths can represent a linear architecture (e.g., a user can go forward or background from one panel or group of panels to another) or a branched (non-linear) architecture (e.g., nodes can be networked and connect to one or other more nodes). An initial, basic node/panel network can automatically be created by the production system 300 based on, for example, the imported assets. Following this, the presentation creator can take production control and adapt the structure of the presentation as he wishes. For example, the creator can use the production system 300 to define events triggered by user navigation actions, traversals of paths, nodes, and panels, and other interactions with the presentation. Such events can include audio playback, filters, visual effects, camera movements, animations, video playback, content element manipulation, and so on.

Once individual fields of view have been defined, virtual camera motion paths are defined in three-dimensions within a 3D canvas, with each motion path being a multi-parametric optimization for human visual interpretation of time scales and the shortest distance between two points. The endpoints on these initial camera “paths” correspond to the (x, y, z) coordinates of an anchor point of a node, panel, or group thereof, which can be defined by the production system 300 during the initial asset import process. The initial path is defined to “curve” along a slope deemed most pleasurable using industry-standardized easing functions (rate of change of speed given time axis on curve). This camera path may be customized at any time by a presentation producer or standardized to travel the shortest possible route (i.e., shortest distance between two points is a straight line). Notably, end users can navigate forward or backward from one node/panel/group to another, and paths can be defined differently for forward versus backward movement. The virtual camera itself can be animated using a non-linear event-based system, in that the camera can be moved within the 3D environment and the virtual “lens” can be changed upon any event in a presentation. Effectively, the virtual camera can be replaced with any other rendering emulator for filters, effects, and the like (e.g., blur, vignette, glitch, etc.).

Once motion paths have been defined, the production system 300 can be employed in a production/editing capacity for customization of the content for user and device specifications. As some examples, the presentation creator can add and adjust text, apply custom styles and formatting to individual words and letters, add and adjust layers and assets, adjust graphical elements (e.g., color overlay, visual effects and filters, blur, depth of field, object coordinates, parallax value of individual layers, etc.), adjust audio elements (e.g., set triggers for audio events), and adjust the event hierarchy (e.g., set triggers for visual effect, sound, or camera effects, such as camera movement, tilt, rotation, lens filters, etc.).

The production system 300 can also be used to define and edit a menu/navigation interface that can be accessed within the 3D presentation. The menu can include visual representations (e.g., thumbnails, snapshots) of nodes or panels that, when selected, navigate the user to the corresponding area of the 3D canvas where the node or panel is located. The menu can also include integrated visual assets, text, images, and other information.

A 3D interactive presentation (nonlinear or linear) can also be exported using the production system 300 to a format that is playable on a variety of systems, such as Sony PlayStation, Microsoft Xbox, Oculus Rift, iOS- and Android-based smartphones, webGL-capable browsers, smart televisions, PCs, Apple Macs, and so on. In some implementations, text content in the presentation is tagged with a unique identifier that defines the location of the text in the presentation and the text and associated metadata is exported into a separately accessible file, such as into an XML/JSON database. This allows for easier revision, dissemination, and adding of localized text in different languages. The exported presentation can also be assigned a unique identifier based on the date of creation and a revision number.

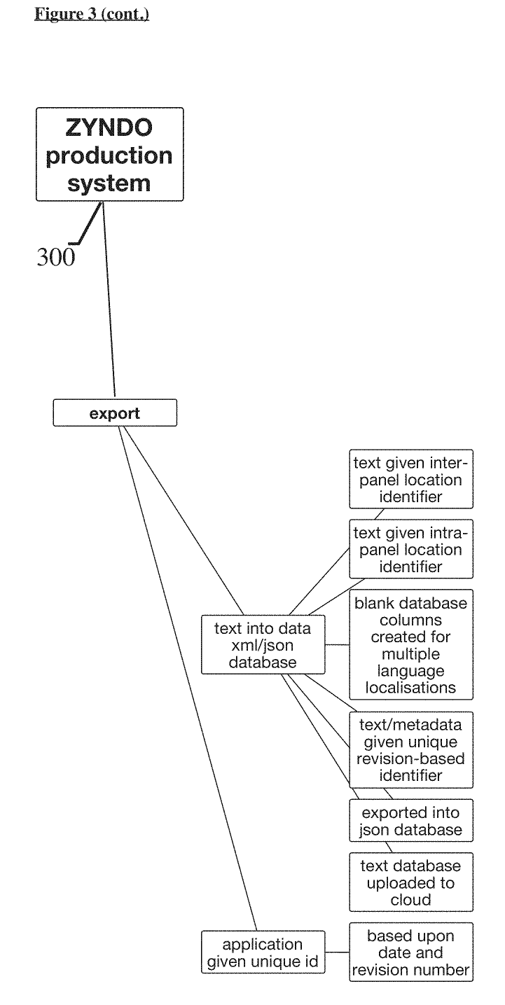

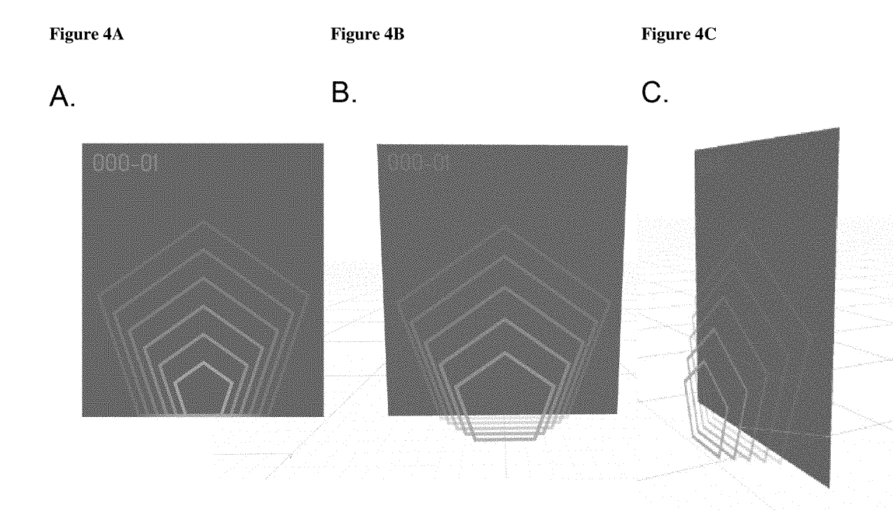

In some implementations, the production system 300 can transform layered image assets (e.g., psd files) into three-dimensional, layered objects which can exhibit a parallax effect to enhance the illusion of depth when viewed in the presentation and when a user interacts (e.g., when changing gaze in VR/AR or tilting the device on which the presentation is being viewed). FIGS. 4A-4C depict an example transformation of such a layered image asset. A 2D image of multiple pentagons contained within each other, with each pentagon in a separate layer (FIG. 4A) is transformed into a 3D image panel, with each pentagon in a separate panel layer in 3D space (FIG. 4B). FIG. 4C shows these new panels rotated in a 3D canvas, emphasizing the spatial separation among the layers. These panel layers can then be viewed at any angled perspective in 3D space.

To achieve this transformation, the production system 300 interprets a 2D layered file and parses the file's image data, including text data. The system 300 calculates the number of layers; reads the name of each layer; exports each individual layer as its own distinct file (e.g., as a .png file with transparency, .jpg, .tif, .pdf, etc.) and saves it using a structured data schema which includes the original layer name; and saves the exported layer file's image data and metadata to a process cache. If a layer includes text, the system 300 caches the text bounding box's coordinates and text data.

Once the layers from a given file have been exported and cached, the production system 300 calculates the total number of layers n and assigns a z-coordinate value defined as its relative value in a simple 1/n equation. The system 300 calculates and assigns optimal (x, y) coordinates for the layer files (as calculated by the producer-defined ideal distance from existing groups in the presentation plus the dimensions of the original layered file), and merges this (x, y) coordinate with the calculated z-space coordinate, to create a unique (x, y, z) coordinate for each individual layer file. The calculated z-coordinate gives each layer a genuine depth in three-dimensional space, as seen in FIG. 4C.

The system 300 also calculates and assigns a relative parallax speed value to each created layer in a similar 1/n equation: this value dictates the speed in which the layer will move on the x- and/or y-axis at runtime (when the presentation is executed). Layers can move as defined by user action during runtime (e.g., layer movement will correspond to changes in gaze in VR/AR, tilt of screen on tablet/phone, movement of mouse, etc.). The combination of the calculated z-coordinate plus the calculated speed value create a parallax effect and reinforce the depth artificially created from the 2D asset. Coordinates and dimensions can be created automatically by the production system 300, and can be fully customized by the presentation producer. Parallax values can also be assigned automatically by the system 300, and can be customized by the producer. The producer can assign parallax values on a per-axis basis so that the relevant layer will move along the x- or y-axis based on a producer-provided factor. Thus, for example, the producer can create layer parallax movement that only goes side-to-side along the x-axis, or only up and down along y-axis, or a fraction thereof on either axis (e.g., mostly lateral movement with just a little longitudinal movement).

The producer can also define each layer and each group per his desired movement type; shortcuts for most common movement types can be provided in the production system 300. Each of the individual layer files can then be run through an optimization process, as follows: each layer is combined into a single sprite, whose size is defined by the producer and/or export medium (e.g., smaller sprites for mobile vs. desktop exports); the resulting sprite is saved into a transparent high-resolution, compressed transparent image file (e.g., .png format), and each layer's sprite coordinates are saved to metadata associated with the layer.

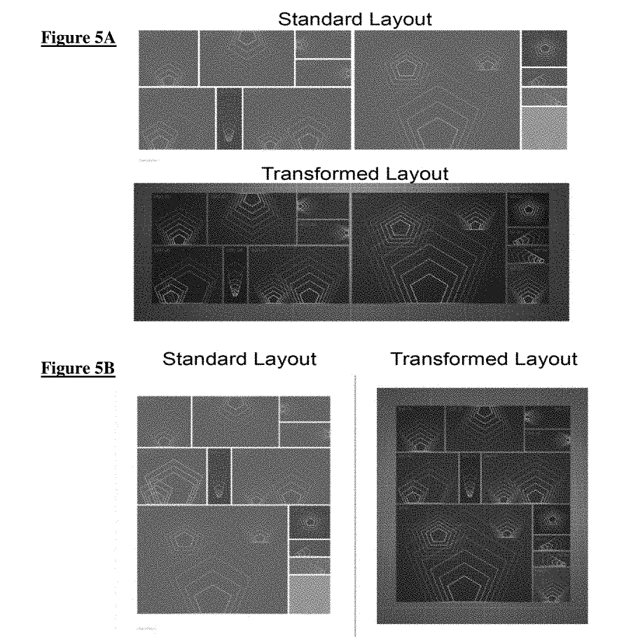

FIGS. 5A and 5B provide examples of how a standard 2D layout of a page can be transformed into 3D with a 3D background. The production system 300 can batch process an unlimited number of layered image files at once. The process can also export individual groups of images (folders of layers) within a larger image file (e.g., a larger .psd of a full spread with groups/folders for each panel/content section), and create individual layered image files. These individual files can then be processed as described above, with respect to FIGS. 4A-4C, enabling further automation of established industry workflows. The production system 300 can be extended to parse data from any type of publishing/creation software (e.g., Adobe Acrobat, Adobe InDesign, Quark Express, Microsoft Publisher, etc.). Both landscape (FIG. 5A) and portrait (FIG. 5B) layouts can be accommodated. In some implementations, multiple 2D pages (e.g., from a print-based asset such as a book) can be transformed into 3D, with pages displayed simultaneously to the user (e.g., in a grid) or in a rendered 3D format (e.g., a 3D book that the user can page through).

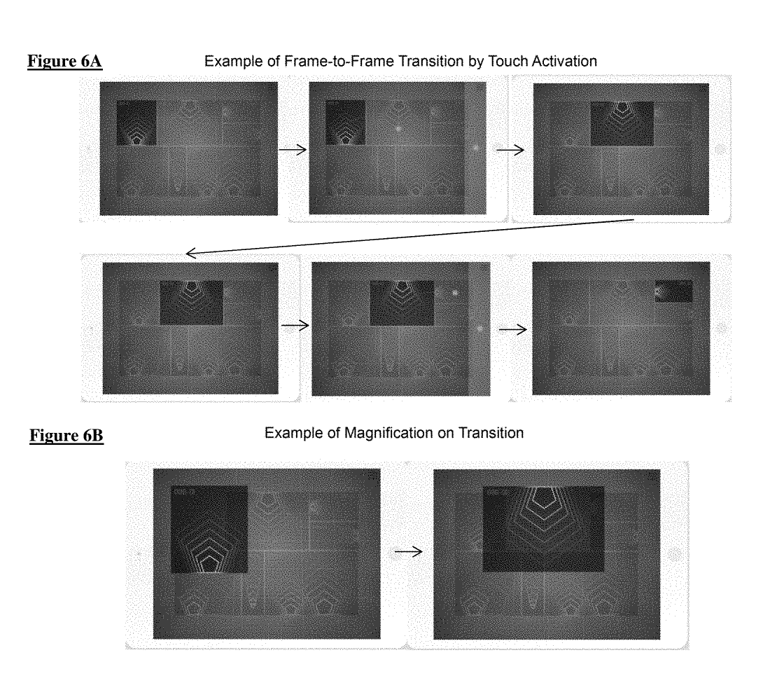

FIGS. 6A and 6B depict how a user-based transition event activation leads to a transition of mixed content within an infinite three-dimensional space. A simple “linear” transition (i.e., moving on one axis, such as the x-axis) is shown in FIG. 6A. Each transition event can trigger a camera animation event, wherein the camera flies from the (x, y, z) coordinates defined for each panel/group. Furthermore, transitions can lead to changes in perceived magnification of the triggered content, as seen in FIG. 6B, by moving the virtual camera closer to a panel, or by actually animating the (x, y, z) anchor of the given group, which the transition event can also trigger.

FIG. 7 shows an example of a menu system infrastructure that is independent of content viewing. Several settings are provided to give user-defined control to the audiovisual components, layout, local movement mechanisms, and macro movement mechanisms. Menus can be fully customized for each presentation and/or delivery mechanism (e.g., custom menus for VR vs. tablet vs. Microsoft Xbox). These menus control distinct variables: audio volume (macro levels or by audio type, i.e., sound effects, soundtrack, voiceover); chapter/issue/edition selection (with marketplace integration for in-app purchases); parallax/movement settings (users can control a multiplier of parallax movement for more/less movement, or none); and text localization (unlimited number of languages supported).

FIG. 8 shows an example of multi-dimensional movement within a 3D environment (e.g., movement of the camera on multiple axes, such as on the x-, y-, and/or z-axis). Panels can be anchored at (x, y, z) coordinates, as detailed above.

FIG. 9 shows an example of different types of movements when transitioning from one panel to the next within a 3D environment. Complex vector trajectories in three-dimensional space, for example, a downward spiral, can be accommodated.

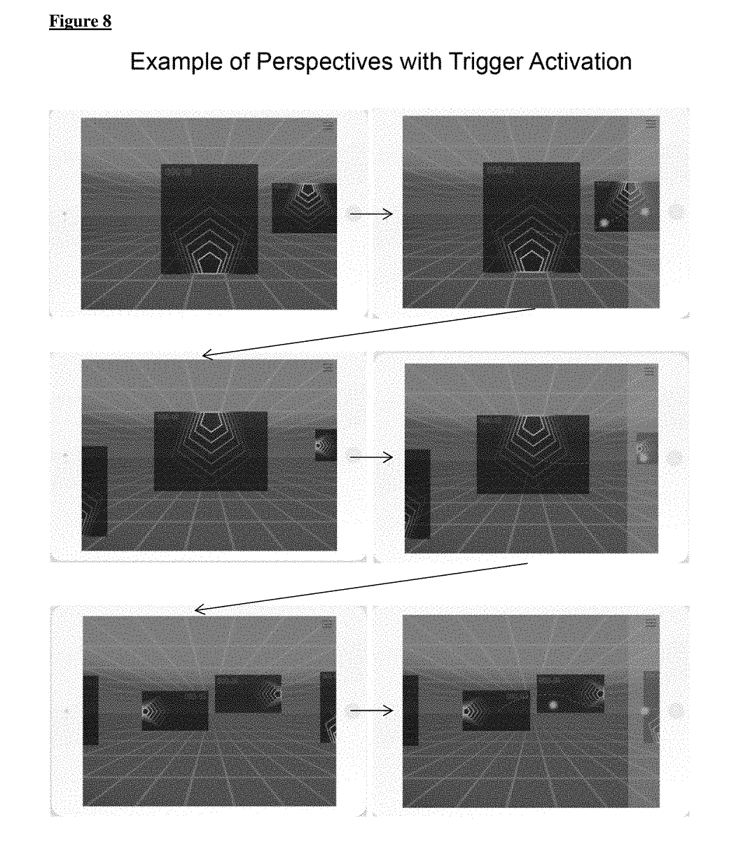

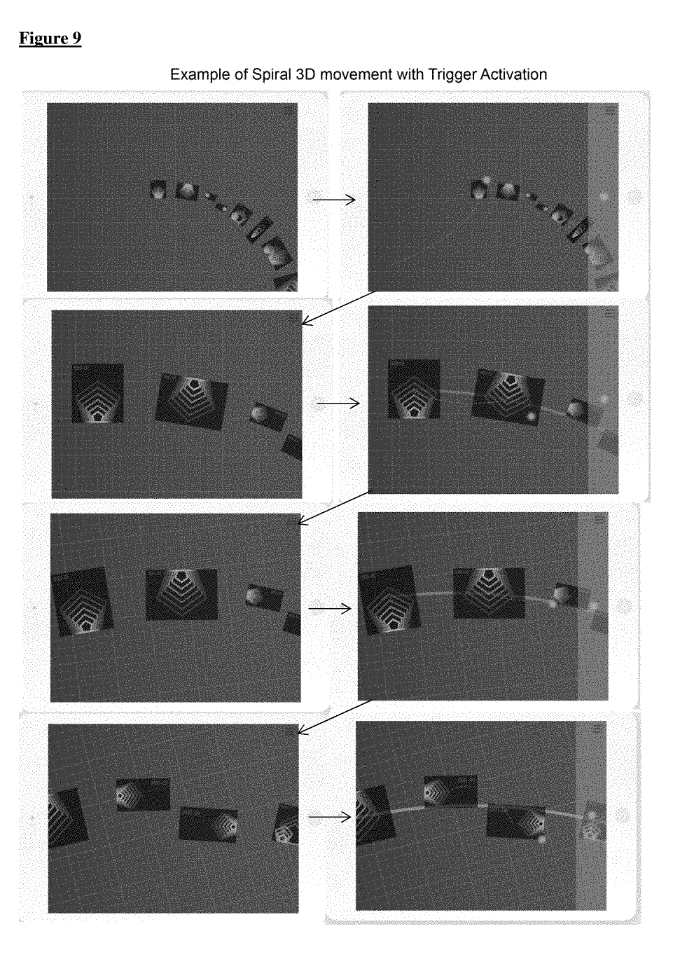

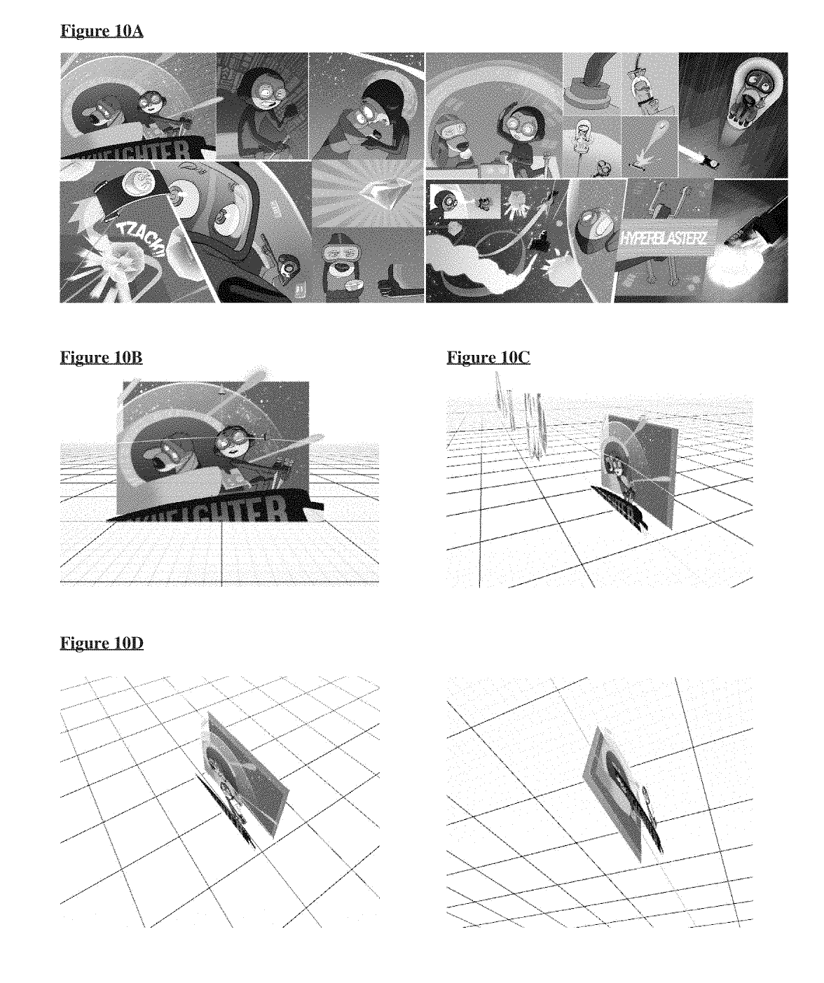

FIGS. 10A-10D depict an example of a use case of the presently described techniques in the area of a digital comic or graphic novel presentation. A standard 2D layout of panels (as that term is used with respect to 2D illustrations) is depicted in FIG. 10A. Each individual illustrated panel can be transformed into an individual panel (as that term is used with respect to the 3D presentations described herein) organized in 3D space as seen in FIGS. 10B (with camera viewing straight on) and FIG. 10C (with camera viewing the panel at an angle, and other panels visible in the background). FIG. 10D depicts a transition from one panel in three-dimensional space to another panel.

The techniques described herein can be implemented in any appropriate hardware or software. If implemented as software, the processes can execute on a system capable of running one or more commercial operating systems such as the Microsoft Windows® operating systems, the Apple OS X® operating systems, the Apple iOS® platform, the Google Android™ platform, the Linux® operating system and other variants of UNIX® operating systems, and the like. Such a system can include, for example, a workstation, a smart or dumb terminal, network computer, smartphone, tablet, virtual reality device, laptop, palmtop, wireless telephone, television, gaming device, music player, mobile telephone, information appliance, personal digital assistant, wireless device, minicomputer, mainframe computer, or other computing device, that is operated as a general purpose computer or a special purpose hardware device that can execute the functionality described herein. Generally, the software can be implemented on a general purpose computing device in the form of a computer including a processing unit, a system memory, and a system bus that couples various system components including the system memory to the processing unit.

The software architecture of the system can include a plurality of software modules stored in a memory and executed on one or more processors. The modules can be in the form of a suitable programming language, which is converted to machine language or object code to allow the processor or processors to read the instructions. The software can be in the form of a standalone application, implemented in any suitable programming language or framework. The visualization system and associated components can be implemented as native applications, web applications, or other form of software. In some implementations, a particular application is in the form of a web page, widget, and/or Java, JavaScript, .Net, Silverlight, Flash, and/or other applet or plug-in that is downloaded to a user device and runs in conjunction with a web browser. An application and a web browser can be part of a single client-server interface; for example, an application can be implemented as a plugin to the web browser or to another framework or operating system. Any other suitable client software architecture, including but not limited to widget frameworks and applet technology can also be employed.

Devices executing the described functionality can communicate with each other through a communications network. The communication can take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network can carry TCP/IP protocol communications and HTTP/HTTPS requests made by a web browser, and the connection between clients and servers can be communicated over such TCP/IP networks. The type of network is not a limitation, however, and any suitable network can be used.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

Implementations of the present techniques in the areas of multimedia presentation are clear examples of use cases. These include, but are not limited to, the digital presentation of textbooks, instructional “how-to” content, magazines, architectural diagrams/schematics, engineering designs/schematics, virtual tours, comic books, graphic novels, scientific presentations of data or publications, marketing content, greeting cards, rich data visualizations, manual/instructional content, and many more. It is to be appreciated that there are a near endless number of applications for the described three-dimensional, interactive presentations.

While various implementations of the present invention have been described herein, it should be understood that they have been presented by example only. Where methods and steps described above indicate certain events occurring in certain order, those of ordinary skill in the art having the benefit of this disclosure would recognize that the ordering of certain steps can be modified and that such modifications are in accordance with the given variations. For example, although various implementations have been described as having particular features and/or combinations of components, other implementations are possible having any combination or sub-combination of any features and/or components from any of the implementations described herein.

1. A method for navigating a three-dimensional environment including content elements related to a common topic, the method comprising:
receiving a three-dimensional presentation comprising a three-dimensional canvas having integrated therein a plurality of two-dimensional content elements from a first content source and a plurality of three-dimensional content elements from a second content source, where in the two-dimensional content elements and the three-dimensional content elements relate to a common topic;
displaying the three-dimensional presentation to a user on a user device by moving a virtual camera about the three-dimensional canvas over a plurality of defined motion paths;
while displaying the three-dimensional presentation to the user, receiving from the user navigation instructions with respect to a first one of the integrated content elements; and
in response to receiving the navigation instructions, spatially manipulating at least one of the three-dimensional canvas and the virtual camera within the three-dimensional canvas to cause a second one of the integrated content elements to provide context relating to the first integrated content element.

2. The method of claim 1, wherein the first integrated content element comprises a two-dimensional content element and wherein the second integrated content element comprises a three-dimensional content element.

3. The method of claim 1, wherein the first integrated content element comprises a three-dimensional content element and wherein the second integrated content element comprises a two-dimensional content element.

4. The method of claim 1, wherein the three-dimensional presentation further comprises an auditory component from a third content source presented in synchronization with navigation of the three-dimensional canvas.

5. The method of claim 1, wherein the first content source and the second content source comprise data and metadata that specify at least one of a common topic and a navigation path for generating informational content for a given field of application.

6. The method of claim 1, wherein the two-dimensional content elements comprise one or more of images, animations, videos, and text.

7. The method of claim 1, wherein the three-dimensional content elements comprise one or more of three-dimensional object models, three-dimensional video, and three-dimensional objects created from layered two-dimensional content elements.

8. The method of claim 1, wherein content elements from the first content source and the second content source are transformed into a common type for manipulation on the three-dimensional canvas.

9. The method of claim 1, wherein displaying the three-dimensional canvas to a user on a user device comprises displaying the three-dimensional canvas in an augmented reality or virtual reality environment using an augmented reality or virtual reality user device.

10. The method of claim 1, further comprising displaying in the three-dimensional canvas a plurality of panels, each panel corresponding to an area of the three-dimensional canvas comprising one or more of the integrated content elements.

11. The method of claim 10, further comprising displaying two or more of the panels in different dimensional layers in the three-dimensional canvas to create a quasi-three-dimensional parallax effect.

12. The method of claim 10, wherein two or more of the panels are displayed in different dimensional layers that change based on an orientation of the user device.

13. The method of claim 10, further comprising:
providing an interface within the three-dimensional canvas comprising visual representations of the plurality of panels;
receiving input from the user indicating a selection of a first one of the visual representations of the panels; and
in response receiving the input, navigating the user to an area of the three-dimensional canvas corresponding to the panel represented by the first visual representation.

14. A system for navigating a three-dimensional environment including content elements related to a common topic, the system comprising:
at least one memory for storing computer-executable instructions; and
at least one processor for executing the instructions stored on the at least one memory, wherein executing the instructions programs the at least one processor to perform operations comprising:
receiving a three-dimensional presentation comprising a three-dimensional canvas having integrated therein a plurality of two-dimensional content elements from a first content source and a plurality of three-dimensional content elements from a second content source, where in the two-dimensional content elements and the three-dimensional content elements relate to a common topic;
displaying the three-dimensional presentation to a user on a user device by moving a virtual camera about the three-dimensional canvas over a plurality of defined motion paths;
while displaying the three-dimensional presentation to the user, receiving from the user navigation instructions with respect to a first one of the integrated content elements; and
in response to receiving the navigation instructions, spatially manipulating at least one of the three-dimensional canvas and the virtual camera within the three-dimensional canvas to cause a second one of the integrated content elements to provide context relating to the first integrated content element.

15. The system of claim 14, wherein the first integrated content element comprises a two-dimensional content element and wherein the second integrated content element comprises a three-dimensional content element.

16. The system of claim 14, wherein the first integrated content element comprises a three-dimensional content element and wherein the second integrated content element comprises a two-dimensional content element.

17. The system of claim 14, wherein the three-dimensional presentation further comprises an auditory component from a third content source presented in synchronization with navigation of the three-dimensional canvas.

18. The system of claim 14, wherein the first content source and the second content source comprise data and metadata that specify at least one of a common topic and a navigation path for generating informational content for a given field of application.

19. The system of claim 14, wherein the two-dimensional content elements comprise one or more of images, animations, videos, and text.

20. The system of claim 14, wherein the three-dimensional content elements comprise one or more of three-dimensional object models, three-dimensional video, and three-dimensional objects created from layered two-dimensional content elements.

21. The system of claim 14, wherein content elements from the first content source and the second content source are transformed into a common type for manipulation on the three-dimensional canvas.

22. The system of claim 14, wherein displaying the three-dimensional canvas to a user on a user device comprises displaying the three-dimensional canvas in an augmented reality or virtual reality environment using an augmented reality or virtual reality user device.

23. The system of claim 14, wherein the operations further comprise displaying in the three-dimensional canvas a plurality of panels, each panel corresponding to an area of the three-dimensional canvas comprising one or more of the integrated content elements.

24. The system of claim 23, wherein the operations further comprise displaying two or more of the panels in different dimensional layers in the three-dimensional canvas to create a quasi-three-dimensional parallax effect.

25. The system of claim 23, wherein two or more of the panels are displayed in different dimensional layers that change based on an orientation of the user device.

26. The system of claim 23, wherein the operations further comprise:
providing an interface within the three-dimensional canvas comprising visual representations of the plurality of panels;
receiving input from the user indicating a selection of a first one of the visual representations of the panels; and
in response receiving the input, navigating the user to an area of the three-dimensional canvas corresponding to the panel represented by the first visual representation.
